(19) United States
(12) Patent Application Publication
(10) Pub. No.: US 2006/0162583 A1
(43) Pub. Date: Jul. 27, 2006

(54) Liquid pressure transfer printing apparatus

(75) Inventors: Masato Yamamori, Aichi (JP); Shinya Tsujimoto, Aichi (JP)

Correspondence Address: GREENBLUM & BERNSTEIN, P.L.C., 1950 ROLAND CLARKE PLACE, RESTON, VA, 20191, US

(73) Assignee: Trinity Industrial Corporation, Aiichi (JP)

(21) Appl. No.: 11/181,800

(22) Filed: Jul. 15, 2005

(30) Foreign Application Priority Data
Jul. 15, 2004 (JP) 2004-208749

(51) Int. Cl. B41D 7/00

(52) U.S. Cl. 101/33

(57) ABSTRACT

A liquid pressure transfer printing apparatus in which a work to be applied with transfer printing is urged onto a film for applying liquid pressure transfer printing supplied to the surface of a liquid in a tank for liquid pressure transfer printing to submerge the film into the liquid comprises a pair of gates each having a suction mechanism for sucking residues not transferred to the submerged work but remained on the surface of the liquid in the tank from the inlet side and the exit side of the tank while the work W is submerged in the liquid, thereby capable of preventing the residues of the film remained on the surface of the liquid in the tank not transferred to the surface of the work from depositing to the surface of the work and forming seeds.

### BACKGROUND OF THE INVENTION

1. Field of the Invention

The present invention concerns a liquid pressure transfer printing apparatus of urging a work to be applied with transfer printing onto a film for applying liquid pressure transfer printing supplied to the surface of water in a tank for liquid pressure transfer printing to submerge the film into water and, more in particular, it relates to a liquid pressure transfer printing apparatus which is suitable to a case, for example, of using a multi-layered film, as a film for applying liquid pressure transfer printing, in which a curable resin layer to form a surface protective coating by being cured under irradiation of actinic energy rays such as UV-rays or by heating is interposed between a film soluble to water or like other aqueous solution and a pattern print layer.

2. Statement of the Related Art

Generally, in a work to be applied with a pattern by liquid pressure transfer printing, a liquid soluble film which has been used as a medium for liquid pressure transfer printing and becomes no more necessary is removed by washing with water or the like, water content adhered on the surface is dried, and then a top coat is applied by clear coating for surface protection as final finishing. However, since a highly skilled technique is necessary for the clear coating of applying a uniform surface protective coating entirely to a work to be applied with transfer printing having various three dimensional shapes, for example, in interior parts or external parts of automobiles and a complicate control is necessary for coating apparatus that automatically conducts such painting operation, it involves a problem that the fabrication cost or installation cost remarkably increases in order to apply the top coating.

In view of the above, it has been proposed a film used for applying liquid pressure transfer printing capable of applying a uniform surface protective coating to a work to be applied with transfer printing by simple means not requiring high skills or complicated control. The film for applying liquid pressure transfer printing of the type described above comprises a multi-layered film in which an insoluble curable resin layer to form a surface protective coating by being cured under the irradiation of actinic energy rays such as UV-rays, or by heating is formed between a liquid soluble film and a pattern print film formed on one surface thereof. After transferring the print layer of the film together with the curable resin layer by liquid pressure to the surface of the work to be applied with transfer printing, a uniform surface protective coating can be applied to the surface of the work merely by a simple fabrication of irradiating UV-rays in a case where the curable resin is formed of a UV-ray curable resin, or by heating the curable resin layer to a curing temperature in a case where the layer is formed of a heat setting resin (JP-A No. 2003-200698).

However, in a case of using the film for applying liquid pressure transfer printing of the type described above, an excess portion of the film not transferred to the work remains as residues on the surface of liquid in the tank for liquid pressure transfer printing and, since the film residues are not liquid soluble and have a curable resin layer at a low specific gravity, they float on the surface of liquid in the tank and may possible be adhered to the work exiting the tank or deposited to a succeeding work that enters the tank to form seeds, etc. to the surface of the work.

In view of the above, liquid in the tank is always circulated so as to flow liquid on the surface on which the film floats in one direction at such a flow rate so as not to crease the film (JP-A No. 2003-261122).

However, since it is difficult to effectively remove the residues of the film floating on the surface of liquid in the tank merely by the means described above, in a case where of intending to speed up the production tact of the liquid pressure transfer printing, thereby improving the production efficiency, residues of the film not transferred to a succeeding work may possibly be deposited to the surface of the work to form seeds on the surface of the work.

### SUMMARY OF THE INVENTION

The present invention intends to solve the problems and attain the subject capable of reliably preventing the residues of a film for applying liquid pressure transfer printing film remaining on the surface of liquid in a tank for liquid pressure transfer printing without transfer to the surface of the work to be applied with transfer printing from depositing to the surface of the work to be applied with transfer printing, which undesirably form seeds on the surface thereof, as well as, capable of reliably recovering the residues of the film having the curable resin layer and re-utilizing the curable resin.

The present invention provides, in a first aspect, a liquid pressure transfer printing apparatus in which a work to be applied with transfer printing is urged onto a film for applying liquid pressure transfer printing supplied to the surface of liquid in a tank for liquid pressure transfer printing to submerge the film into liquid, wherein the apparatus comprises a pair of gates each having a suction mechanism for sucking residues of the film that floats on the surface of liquid in the tank from the inlet side and the exit side of the tank where the work enters into and exits from the tank and discharging the sucked residues out of the tank while the work is submerged in the liquid. The term liquid means herein to include aqueous liquid, that is, water and other liquids mainly comprising water.

According to the invention, when a work to be applied with transfer printing is urged onto the film for applying liquid pressure transfer printing supplied to the surface of liquid in the tank for the liquid pressure transfer printing to submerge the film into a liquid, since the residues of the film not transferred to the work but floating on the surface of liquid in the tank are sucked into the pair of gates each having the suction mechanism and discharged out of the tank while the work is submerged in liquid, it is possible to prevent occurrence of seeds on the surface of the work that enters into and exits from the tank. Further, since both of the gates suck the residues of the film floating on the surface of the liquid in the tank from both of the inlet side and the exit side of the liquid pressure transfer printing tank where the work enters into and exits from the tank.

Further, in a preferred embodiment, in which both of the gates are disposed movably along the longitudinal direction of the tank where the work enters into and exits from the tank, residues of the film not transferred to the work can be recovered while following after the movement of the work that enters into and exits from the tank thereby preventing deposition of the residues to the surface of the work.

Further, in another preferred embodiment, in which both of the gates are disposed such that they can advance and retract between a standby position completely submerged in the liquid in the tank and a suction position for sucking the residues, residues that can not be recovered completely by both of the gates can be flushed away by the stream at the liquid surface during standing of both of the gates in the liquid in the tank, and deposition of the contaminants by the residues to both of the gates can be prevented.

A further embodiment in which each of the gates comprises a slit nozzle having a suction port that opens slitwise along the lateral direction of the tank and connected with a suction hose for sucking the residues floating on the surface of the liquid in the tank from the suction port and discharging them to the outside of the tank—has an advantage of simple and easy constitution and with no increase for the manufacturing cost.

In a further embodiment in which both of the gates are arranged so as to correspond to one end and the other end of the film to suppress swelling and diffusion of the film caused by an activating agent upon coating the activating agent to the film that is cut into a predetermined size and supplied to the surface of the liquid in the tank, since the pattern printed on the film is clearly transferred to the surface of the work at a size approximate to the original size, it has an advantage capable of improving the transferred.

In a further preferred embodiment in which a pair of conveyors for transporting the film that is cut into a predetermined size and supplied to the surface of the liquid in the tank along the longitudinal direction of the tank are disposed along the right and left side walls of the tank, since the film can be moved reliably to the transfer position while suppressing the swelling of the film caused by the activating agent by the right and left side walls, this provides an advantage capable of improving the transfer quality and speeding up the production tact of the liquid pressure transfer printing to improve the production efficiency.

As described above, the present invention provides an effect capable of effectively recovering the residues of the film not transferred to the surface of the work but remained on the surface of the liquid in the tank thereby capable of reliably preventing seeds from resulting in the surface of the work.

In a most preferred embodiment of a liquid pressure transfer printing apparatus according to the invention, a work to be applied with transfer printing is submerged in a liquid while urging it onto a film for applying liquid pressure transfer printing supplied to the surface of a liquid in a tank for liquid pressure transfer printing, a pair of gates each having a suction mechanism are disposed for sucking the residues of the film not transferred to the work but floating on the surface of the liquid in the tank from both of the inlet side and the exit side of the tank where the work enters into and exits from the tank and discharging them to the outside of the tank during submerge of the residues in the liquid, each of the gates comprises a slit nozzle having a suction port that opens slitwise along the lateral direction of the tank and connected with a suction hose for sucking the residues from the suction port and discharging them out of the tank, the gates are disposed moveably along the longitudinal direction of the tank where the work enters into and exits from tank and disposed such that they can advance and retract between a standby position where they are completely immerged in the liquid in the tank and a suction position for the residues so as to correspond to one side and the other side of the film when an activating agent is coated to the film that is cut into a predetermined size and supplied to the surface of the liquid in the tank, so that swelling and diffusion of the film due to the activating agent is suppressed.

### DESCRIPTION OF THE ACCOMPANYING DRAWING

The present invention is to be described specifically by way of preferred embodiments with reference to the accompanying drawings, wherein

FIG. 1 is a vertical cross sectional view showing an example of a liquid pressure transfer printing apparatus according to the present invention;

FIG. 2 is a transversal cross sectional view of a liquid pressure transfer printing apparatus showing FIG. 1;

FIG. 3 is a plane view of a liquid pressure transfer printing apparatus shown in FIG. 1; and

FIG. 4 is a view explaining the operation of the liquid pressure transfer printing apparatus shown in FIG. 1

### DESCRIPTION OF PREFERRED EMBODIMENTS

In the drawings, are shown tank 1 for liquid pressure transfer printing (hereinafter also sometimes referred to as a tank), a work W to be applied with transfer printing under liquid pressure (hereinafter also sometimes referred to as a work) which enters into and exits from the tank 1 being suspended from a transportation jig 12, a film for applying liquid pressure transfer printing (hereinafter also sometimes referred to as a film) cut to a predetermined size and supplied to the surface of the liquid in the tank 1, a pair of gates 3A and 3B for sucking residues of the film F floating on the surface of the liquid in the tank 1 from both of the inlet side 1A and the exit side 1B of the tank 1 where the work W enters into and discharging the residues out of the tank 1, and a pair of chain conveyors 4C and 4D for transporting the film F cut into a predetermined size and supplied to surface of the liquid in the tank 1 from the inlet side 1A to the exit side 1B along the longitudinal direction of the tank 1. The conveyors 4C and 4D are disposed along the inner side of right and left side walls 5C and 5D of the tank 1.

Each of the gates 3A and 3B having a suction mechanism is constituted as a slit nozzle having a suction port 6 that opens slitwise along the lateral direction of the tank 1 and connected with a suction hose 7 for sucking the residues of the film F floating on the surface of the liquid in the tank 1 from the suction port 6 and discharging them to the outside of the tank 1.

Further, both the gates 3A and 3B are located movably along the longitudinal direction of the tank 1 by being supported on vertically rotating arms 10 provided to each pair of right and left trucks 8C, 8D and 9C, 9D that run along upper ends of right and left side walls 5C and 5D of the printing tank 1 at both ends thereof. The gates can be advanced and retracted between a standby position completely submerged into the liquid of the tank 1 and a sucking position for sucking the residues of the film F floating on the surface of the liquid in the tank 1. That is, both of the gats 3A and 3B are adapted such that they can move in the longitudinal direction of the tank 1 by the running of the trucks 8C, 8D and 9C, 9D along the right and left side walls 5C and 5D of the tank 1, as well as can be advanced or retracted between the standby position completely submerged into the liquid in the tank 1 and the suction position for sucking the residues of the film F floating on the surface of liquid in the tank 1 by vertical rotation of each of the arms 10 to disposed to the trucks 8C, 8D and 9C, 9D.

Further, the suction hoses 7 to be connected with the slit nozzles that constitute both of the gates 3A and 3B and cables (not illustrated) for running the trucks 8C, 8D and 9C, 9D and supplying a driving power source or a driving control signal, etc. for rotating the arms 10 are flexibly supported by paired cables 11 such that they can follow the movement of the gates 3A, 3B, and the trucks 8C, 8D and 9C, 9D.

The film F for applying transfer printing under liquid pressure comprises, for example, a curable resin layer made of a liquid soluble film comprising polyvinyl alcohol or the like, a pattern printing layer formed on one surface thereof, a transparent UV-ray curable resin as a surface protective coat formed therebetween but this not restrictive and those generally used so far with no such curable resin layer may also be used.

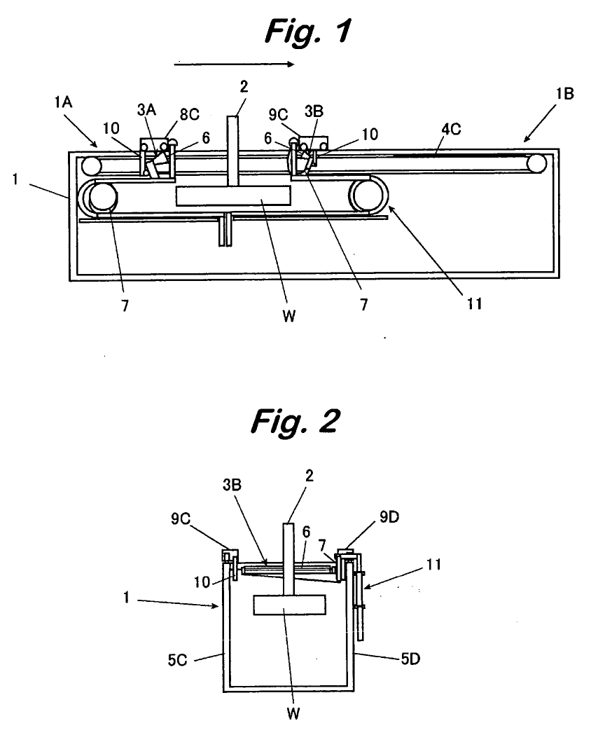

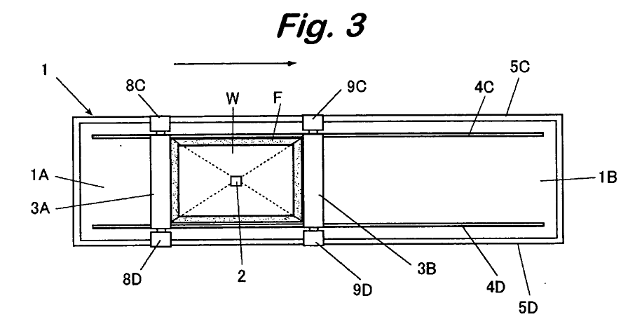

The operation and the function and the effect of the liquid pressure transfer printing apparatus having thus been constituted are to be described bellow. At the surface of the liquid in the tank 1 for liquid pressure transfer printing, a liquid stream is continuously formed in the direction from the inlet side 1A to the exit side 1B of the tank where the work W to be applied with transfer printed enters into and exits from the tank, so that flowing residues of the film and dusts flowing on the surface are driven to the exit side 1B as shown by arrows shown in FIG. 1 and FIG. 3 like in existent apparatus. Further, in a case where the film F applying liquid pressure transfer printing is not supplied to the surface of the liquid in the tank 1, each of the arms 10 for the trucks 8C, 8D and 9C, 9D is lowered immediately below as shown in FIG. 1 and FIG. 3 so as to keep the gates 3A and 3B to standby in a state to be submerged completely into liquid on the inlet side 1A of the tank 1. This can prevent contaminants such as the residues of the film and dusts caused to flow by the liquid stream to the surface of the liquid in the tank 1 from depositing on the gates 3A and 3B.

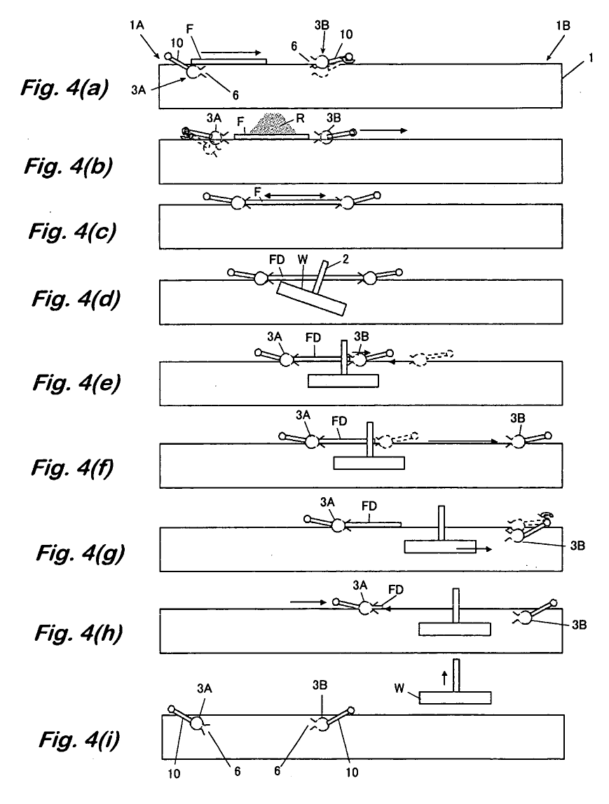

Then, when the film F cut into a predetermined size and supplied to the surface of the liquid in the tank 1 for liquid pressure transfer printing, the gates 3B standing so far to the downstream of the liquid stream caused to the liquid surface advances to a suction position capable of sucking the residues of the film floating on the surface to inhibit the film F from passing over the gate 3B as shown in FIG. 4(a). When the film F passes over the gate 3A standing in liquid at the upstream of the liquid stream, the gate 3A also advances to the suction position capable of sucking the residues of the film floating on the surface as shown in FIG. 4(b). That is, both of the gates 3A and 3B are arranged such that they correspond to one end and the other end of the film F, in which an activating agent R is coated on the film F.

Then, in a state as shown in FIG. 4(c) where swelling and diffusion of the film F by the activating agent are restricted by both of the gats 3A and 3B, the work W is urged onto the film F and submerged into liquid. Then, since the pattern printed to the film F is transferred clearly onto the surface of the work W with no enlargement at a size approximate to an original size, the transfer printing quality is improved remarkably.

Further, along with the movement of the work W which is submerged in the tank 1 and conveyed from the inlet side 1A to the exit side 1B of the tank, residues FD of the film F not transferred to the work W but remained on the surface of the liquid in the tank 1 are transported by the conveyers 4C and 4D from the inlet side 1A to exit side 1B of the tank 1, and the gates 3A and 3B located opposed to each other on both sides of the residues FD are moved as shown in FIG. 4(e) to (h), while being moved entirely by the trucks 8C, 8D and 9C, 9D from the inlet side 1A to the exit side 1B of the tank 1. In this cause, they are moved and effectively suck the residues FD of the film floating on the surface of the liquid in the tank 1 in a short time and discharge them to the outside of the tank 1.

That is, in order that the residues FD of the film that were not transferred to the work W but remained on the surface of liquid in the tank 1 are not deposited on the surface of the work W exiting from the tank 1, about one-half amount of the residues is sucked at first by the gate 3B on the exit side B as shown in FIG. 4(e), then the gate 3B is rapidly retracted to a position not hindering the exit of the work W as shown in FIG. 4(f) and the gate 3B is caused to standby in the liquid at the retracted position as shown in FIG. 4(g). Then, the remaining residues FD not sucked by the gate 3B on the exit side B are sucked rapidly by the gate 3A on the inlet side 1A while following up the remaining residues FD by the gate 3A.

Then, when the work W submerged in the tank 1 is pulled up from the liquid and discharged out of the tank, both the gates 3A and 3B move to the inlet side 1A of the tank 1 as shown in FIG. 4(i), and standby in the liquid till the supply of a succeeding film for applying transfer printing to a succeeding work. In the apparatus of this embodiment, the liquid pressure transfer printing film cut into a predetermined size is supplied to the liquid surface of the tank but a strand of film may also be supplied continuously to the surface of the liquid in the tank in the liquid pressure transfer printing apparatus according to the invention.

The present disclosure relates to subject matter contained in priority Japanese Patent Application No. 2004-208,749 filed on Jul. 15, 2004, the contents of which is herein expressly incorporated by reference in its entirety.

1. A liquid pressure transfer printing apparatus in which a work to be applied with transfer printing is urged onto a film for applying liquid pressure transfer printing supplied to the surface of a liquid in a tank for liquid pressure transfer printing to submerge the film into the liquid, wherein the apparatus comprises a pair of gates each having a suction mechanism for sucking residues of the film that floats on the surface of the liquid in the tank from the inlet side and the exit side of the tank where the work enters into and exits from the tank and discharging the sucked residues out of the tank while the work is submerged in liquid.

2. A liquid pressure transfer printing apparatus according to claim 1, wherein both of the gates are disposed movably along the longitudinal direction of the tank where the work enters into and exits from the tank.

3. A liquid pressure transfer printing apparatus according to claim 1, wherein both of the gates are disposed such that they can advance and retract between a standby position completely submerged in the liquid in the tank and a suction position for sucking the residues.

4. A liquid pressure transfer printing apparatus according to claim 1, wherein each of the gates comprises a slit nozzle having a suction port that opens slitwise along the lateral direction of the tank and connected with a suction hose for sucking the residues from the suction port and discharging them to the outside of the tank.

5. A liquid pressure transfer printing apparatus according to claim 1, wherein both of the gates are arranged so as to correspond to one end and the other end of the film to suppress swelling and diffusion of the film caused by an activating agent upon coating the activating agent to the film that is cut into a predetermined size and supplied to the surface of the liquid in the tank.

6. A liquid pressure transfer printing apparatus according to claim 1, wherein a pair of conveyors for transporting the film that is cut into a predetermined size and supplied to the surface of the liquid in the tank along the longitudinal direction of the tank are disposed along the right and left side walls of the tank.

7. A liquid pressure transfer printing apparatus according to claim 2, wherein both of the gates are disposed such that they can advance and retract between a standby position completely submerged in the liquid in the tank and a suction position for sucking the residues.

8. A liquid pressure transfer printing apparatus according to claim 2, wherein each of the gates comprises a slit nozzle having a suction port that opens slitwise along the lateral direction of the tank and connected with a suction hose for sucking the residues from the suction port and discharging them to the outside of the tank.

9. A liquid pressure transfer printing apparatus according to claim 3, wherein each of the gates comprises a slit nozzle having a suction port that opens slitwise along the lateral direction of the tank and connected with a suction hose for sucking the residues from the suction port and discharging them to the outside of the tank.

10. A liquid pressure transfer printing apparatus according to claim 2, wherein both of the gates are arranged so as to correspond to one end and the other end of the film to suppress swelling and diffusion of the film caused by an activating agent upon coating the activating agent to the film that is cut into a predetermined size and supplied to the surface of the liquid in the tank.

11. A liquid pressure transfer printing apparatus according to claim 4, wherein both of the gates are arranged so as to correspond to one end and the other end of the film to suppress swelling and diffusion of the film caused by an activating agent upon coating the activating agent to the film that is cut into a predetermined size and supplied to the surface of the liquid in the tank.

12. A liquid pressure transfer printing apparatus according to claim 2, wherein a pair of conveyors for transporting the film that is cut into a predetermined size and supplied to the surface of the liquid in the tank along the longitudinal direction of the tank are disposed along the right and left side walls of the tank.

13. A liquid pressure transfer printing apparatus according to claim 3, wherein a pair of conveyors for transporting the film that is cut into a predetermined size and supplied to the surface of the liquid in the tank along the longitudinal direction of the tank are disposed along the right and left side walls of the tank.

14. A liquid pressure transfer printing apparatus according to claim 4, wherein a pair of conveyors for transporting the film that is cut into a predetermined size and supplied to the surface of the liquid in the tank along the longitudinal direction of the tank are disposed along the right and left side walls of the tank.

15. A liquid pressure transfer printing apparatus according to claim 5, wherein a pair of conveyors for transporting the film that is cut into a predetermined size and supplied to the surface of the liquid in the tank along the longitudinal direction of the tank are disposed along the right and left side walls of the tank.
